(19) United States
(12) Patent Application Publication
(10) Pub. No.: US 2023/0136191 A1
(43) Pub. Date: May 4, 2023

(54) IMAGE CAPTURING SYSTEM AND METHOD FOR ADJUSTING FOCUS

(71) Applicant: SONIC STAR GLOBAL LIMITED, Road Town (VG)

(72) Inventors: YI-PIN CHANG, HSINCHU CITY (TW); CHIA-LUN TSAI, NEW TAIPEI CITY (TW)

(21) Appl. No.: 17/696,869

(22) Filed: Mar. 17, 2022

Related U.S. Application Data
(60) Provisional application No. 63/273,457, filed on Oct. 29, 2021.

(51) Int. Cl. H04N 5/232; G06F 3/01; G06V 10/70; G06V 20/70; H04N 5/225; G06T 7/20

(52) U.S. Cl. CPC H04N 5/232127; G06F 3/013; G06T 7/20; G06V 10/70; G06V 20/70; H04N 5/2258; H04N 5/23218; H04N 5/232935; H04N 5/232939

(57) ABSTRACT

The present application discloses an image capturing system and a method for adjusting focus. The image capturing system includes a first image-sensing module, a plurality of processors, a display panel, and a second image-sensing module. A first processor detects objects in the preview image sensed by the first image-sensing module and attach labels to the detected objects. The display panel displays the preview image with the labels of the objects detected. The second image-sensing module acquires user’s gaze data. A second processor selects a target in the preview image according to a gazed region on the display panel that the user is looking at, and controls the first image-sensing module to focus on the target. The first processor, the second processor, and/or a third processor detect the gazed region according to the user’s gaze data.

### TECHNICAL FIELD

The present disclosure relates to an image capturing system, and more particularly, to an image capturing system using gaze-based focus control.

### DISCUSSION OF THE BACKGROUND

Autofocus is a common function for current digital cameras in electronic devices. For example, an application processor of a mobile electronic device may achieve the autofocus function by dividing a preview image into several blocks and selecting a block having most textures or details to be a focus region. However, if the block selected by the electronic device does not meet a user’s expectation, the user needs to manually select the focus region on his/her own. Therefore, a touch focus function has been proposed. The touch focus function allows the user to touch a block on a display touch panel of the electronic device that he/she would like to focus on, and the application processor then adjusts the focus region accordingly.

However, the touch focus function requires complex and unstable manual operations. For example, the user may have to hold the electronic device, touch a block to be focused on, and take a picture all within a short period of time. Since the block may contain a number of objects, it can be difficult to know which the exact object that the user wants to focus on is, thus causing inaccuracy and ambiguity. Furthermore, when the user touches the display touch panel of the electronic device, such action may shake the electronic device or alter a field of view of a camera. In such case, a region the user touches may no longer be the actual block the user wants to focus on, and consequently a photo taken may not be satisfying. Therefore, finding a convenient means to select the region to focus on with greater accuracy when taking pictures has become an issue to be solved.

### SUMMARY

One embodiment of the present disclosure discloses an image capturing system. The image capturing system includes a first image-sensing module, a plurality of processors, a display panel, and a second image-sensing module. A first processor of the processors is configured to detect a plurality of objects in a preview image sensed by the first image-sensing module and attach labels to the detected objects. The second image-sensing module is for data acquisition of a user’s gaze. A second processor of the processors is configured to select a target from the detected objects with the labels in the preview image according to a gazed region on the display panel that the user is gazing at, and control the first image-sensing module to perform a focusing operation with respect to the target. At least one of the processors is configured to detect the gazed region on the display panel according to user’s gaze data acquired during the data acquisition.

Another embodiment of the present disclosure discloses a method for adjusting focus. The method comprises capturing, by a first image-sensing module, a preview image; detecting a plurality of objects in the preview image; attaching labels to the detected objects, displaying, by a display panel, the preview image with the labels of the detected objects; acquiring data of a user’s gaze, detecting a gazed region on the display panel that the user is gazing at according to the user’s gaze data, selecting a target from the detected objects with the labels in the preview image according to the gazed region, and controlling the first image-sensing module to perform a focusing operation with respect to the target.

Since the image capturing system and the method for adjusting focus provided by the embodiments of the present disclosure allow a user to select a target or a specific subject to be focused by means of gaze-based focus control, the user can concentrate on holding and stabilizing the camera or the electronic device while composing the image without touching the display panel for focusing, thereby simplifying an image-capturing process and avoiding shaking the image capturing system.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows an image capturing system according to one embodiment of the present disclosure.

FIG. 2 shows a method for adjusting focus according to one embodiment of the present disclosure.

FIG. 3 shows a preview image according to one embodiment of the present disclosure

FIG. 4 shows the preview image in FIG. 3 with labels of the objects.

FIG. 5 shows an image of the user according to one embodiment of the present disclosure.

FIG. 6 shows an image capturing system according to another embodiment of the present disclosure.

FIG. 7 shows a second image-sensing module in FIG. 1 according to one embodiment of the present disclosure.

FIG. 8 shows the display panel of the image capturing system in FIG. 1 according to one embodiment of the present disclosure.

FIG. 9 shows a first image-sensing module according to one embodiment of the present disclosure.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments.” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

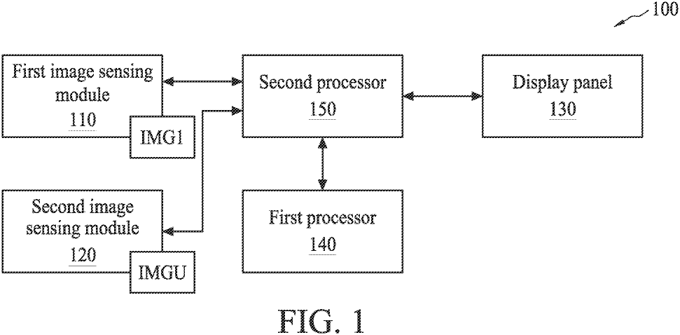

FIG. 1 shows an image capturing system 100 according to one embodiment of the present disclosure. The image capturing system 100 includes a first image-sensing module 110, a second image-sensing module 120, a display panel 130, a first processor 140. and a second processor 150. In the present embodiment, the first image-sensing module 110 may be used to sense pictures of a desired scene, and the display panel 130 may display an image sensed by the first image-sensing module 110 for a user’s preview. In addition, the second image-sensing module 120 is for data acquisition of the user’s gaze so as to trace a gazed region on the display panel 130 that the user is gazing at. That is, the image capturing system 100 provides a gaze-to-focus function that allows the user to select an object that the first image-sensing module 110 should focus on by gazing at the object of interest in the image shown by the display panel 130.

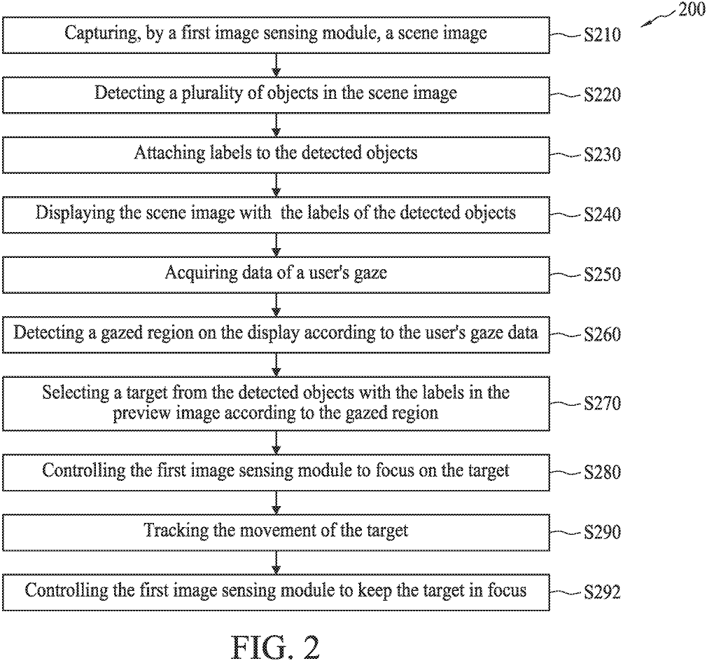

FIG. 2 shows a method 200 for adjusting focus according to one embodiment of the present disclosure. The method 200 includes steps S210 to S292, and can be applied to the image capturing system 100.

In step S210, the first image-sensing module 110 may capture a preview image IMG1, and in step S220, the first processor 140 may detect objects in the preview image IMG1. In some embodiments, the first processor 140 may be an artificial intelligence (AI) processor, and the first processor 140 may detect the objects according to a machine learning model, such as a deep learning model utilizing a neuro-network structure. For example, a well-known object detection algorithm, YOLO (You Only Live Once), proposed by Joseph Redmon et al. in 2015, may be adopted. In some embodiments, the first processor 140 may comprise a plurality of processing units, such as neural-network processing units (NPU) for parallel computation so that a speed of object detection based on the neuro-network can be improved. However, the present disclosure is not limited thereto. In some other embodiments, other suitable models for object detection may be adopted, and a structure of the first processor 140 may be adjusted accordingly.

Furthermore, in some embodiments, to improve an accuracy of object detection, the preview image IMG1 captured by the first image-sensing module 110 may be subject to image processing to have a better quality. For example, the image capturing system 100 may be incorporated in a mobile device, and the second processor 150 may be an application processor of the mobile device. In such case, the second processor 150 may include an image signal processor (ISP) and may perform image enhancement operations, such as auto white balance (AWB), color correction or noise reduction, on the preview image IMG1 before the first processor 140 detects the objects in the preview image IMG1 so that the first processor 140 can detect objects with greater accuracy.

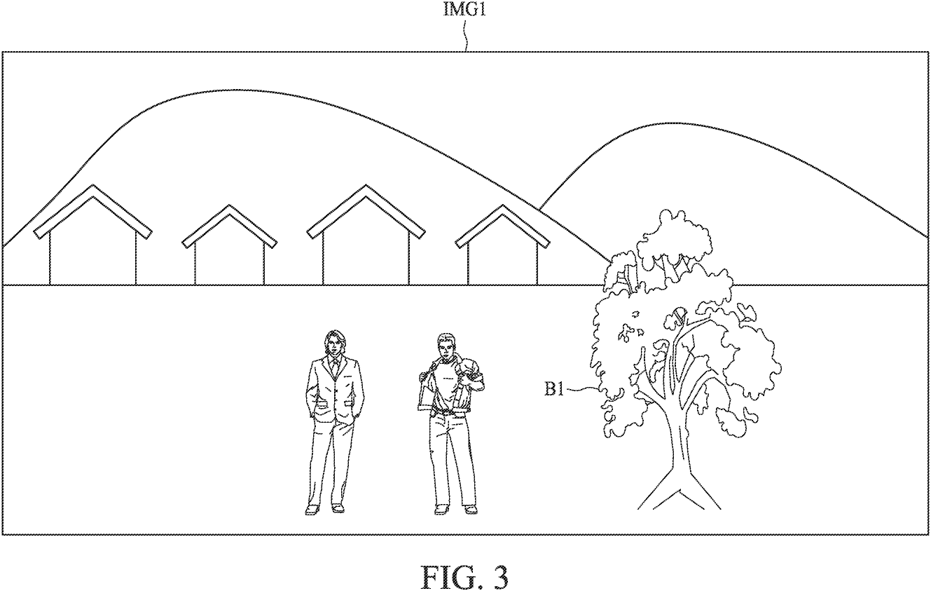

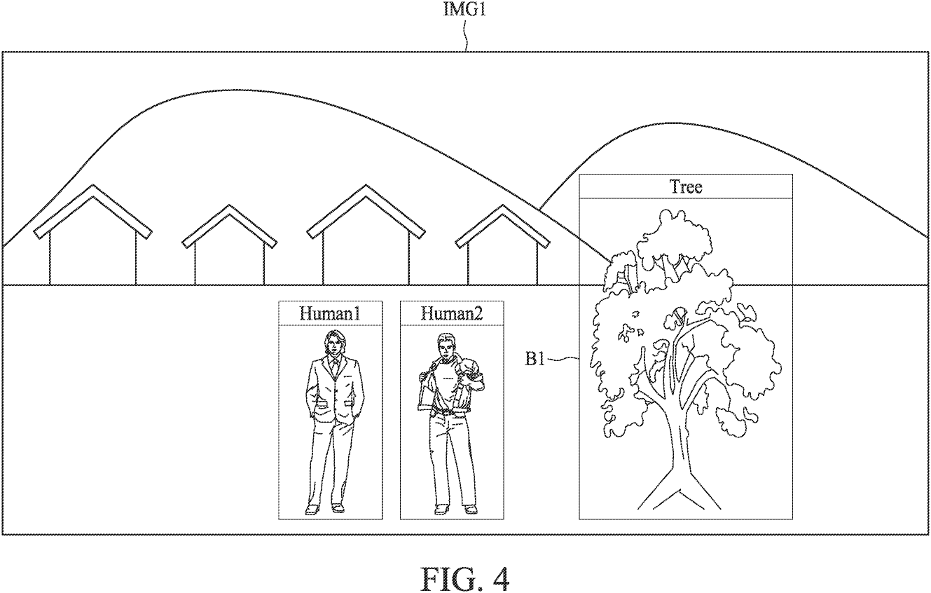

After the objects are detected, the first processor 140 may attach labels to the detected objects in step S230, and the display panel 130 may display the preview image IMG1 with the labels of the detected objects in step S240. FIG. 3 shows the preview image IMG1 according to one embodiment of the present disclosure, and FIG. 4 shows the preview image IMG1 with labels of the objects that have been detected.

As shown in FIG. 4, the labels of the objects been detected include names of the objects and bounding boxes surrounding the objects. For example, in FIG. 4, a tree in the preview image IMG1 is detected, and a label of the tree includes a name of the object “Tree” and a bounding box B1 that surrounds the tree. However, the present disclosure is not limited thereto. In some other embodiments, since there may be a lot of same objects in the preview image IMG1, the label may further include a serial number of the object. For example, in FIG. 4, the label of a first person may be “Human 1,” and a label of a second person may be “Human 2.” Furthermore, in some other embodiments, the names of objects may be omitted, and unique serial numbers may be applied for identifying different objects. That is, a designer may define the label according to his/her needs to improve a user experience. In some embodiments, the labels of objects may include at least one of serial numbers of the objects, names of the objects, and bounding boxes surrounding the objects.

In step S250, the second image-sensing module 120 may acquire data of a user’s gaze. For example, the second image-sensing module 120 may capture video or images of the user’s eyes for gaze detection. In the present embodiment, the image capturing system 100 may be incorporated in a mobile device, such as a smart phone or a tablet. In such case, if the display panel 130 is installed on a front side of the mobile device, then the first image-sensing module 110 may be installed on a rear side while the second image-sensing module 120 may be installed on the front side and may be adjacent to or under the display panel 130. Therefore, when a user uses the first image-sensing module 110 to take a picture of a desired scene, the second image-sensing module 120 may be used to sense the user’s eyes for gaze data acquisition to estimate where the user is looking. In some embodiments, the first image-sensing module 110 and the second image-sensing module 120 may be cameras that include charge-coupled device (CCD) sensors or complementary metal-oxide semiconductor (CMOS) sensors for sensing lights reflected from objects in the scene.

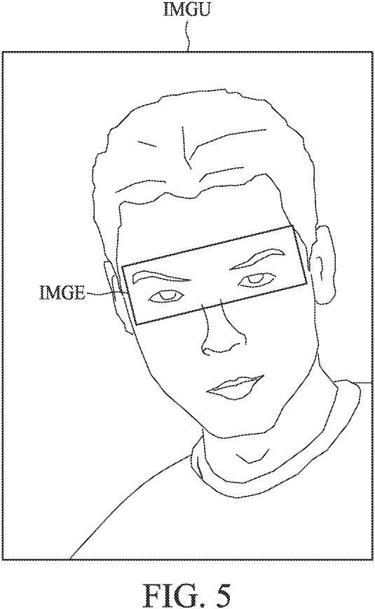

FIG. 5 shows a snapshot IMGU of the user according to one embodiment of the present disclosure. In the present embodiment, the user’s gaze data includes the snapshot IMGU to detect, as depicted in step S260. a gazed region on the display panel that the user is gazing at. For example, the first processor 140 may detect the user’s eyes in the snapshot IMGU according to an eye-detecting algorithm, and then, after the eyes are detected, the first processor 140 may further analyze the appearance and/or features of the eyes so as to predict the gazed region, i.e. where the user is looking, according to a gaze-tracking algorithm.

In some embodiments, a prediction model, such as a deep learning model, can be trained in advance, and an image IMGE of the user’s eye can be cropped from the snapshot IMGU and sent to the prediction model as input data. For example, an appearance-based gaze-tracking algorithm may employ a plurality of cropped images of the eyes for training of regression functions as observed in Gaussian process, multilayered networks, and manifold learning. After the regression function has been trained, an eye movement angle of the user’s gaze can be predicted by mapping the eye image IMGE of the user with the regression function, and the second processor 150 may further perform a calibration process to project the eye movement angle of the user’s gaze onto a corresponding position on the display panel 130. Consequently, the gazed region on the display panel 130 can be obtained. However, the present disclosure is not limited thereto. In some other embodiments, a different type of gaze-tracking algorithm may be chosen. For example, a feature-based gaze-tracking algorithm may be adopted.

In addition, according to characteristics of the adopted algorithm, different processor(s) may be utilized. For example, in some other embodiments, instead of the first processor 140, the second processor 150 may be utilized for gaze tracking. In yet other embodiments, if the first processor 140 and the second processor 150 are not suitable for operating the chosen gaze-tracking algorithm, the image capturing system 100 may further include a third processor that is compatible with the chosen gaze-tracking algorithm to perform the gaze tracking. Nevertheless, in some embodiments, the gaze tracking may be performed by more than one processor, for example, two or three processors may be utilized for gaze tracking.

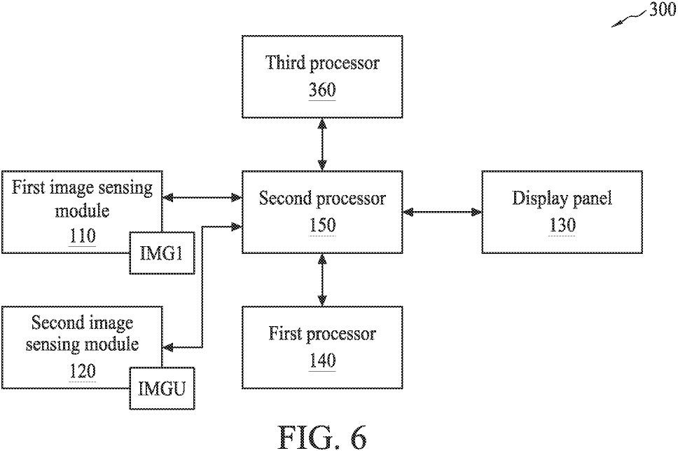

FIG. 6 shows an image capturing system 300 according to one embodiment of the present disclosure. The image capturing system 300 and the image capturing system 100 have similar structures and can both be used to perform the method 200. However, as shown in FIG. 6, the image capturing system 300 further includes a third processor 360. In the embodiment of FIG. 6, the first processor 140 and the third processor 360 can be used together to track the gazed region in step S260. For example, the first processor 140 may be used for eye detection, and the third processor 360 may be used for gaze tracking according to the eye image provided by the first processor 140.

Furthermore, to improve an accuracy of the gaze tracking, characteristics of human eyes may be taken into consideration for providing more details and features of the eyes in the image IMGE. For example, a sclera may reflect most of infrared light while a pupil may absorb most of the infrared light. Therefore, by emitting infrared light to the user’s eyes and sensing a reflection of the infrared light from the user’s eyes, more details and features of the eyes may be obtained.

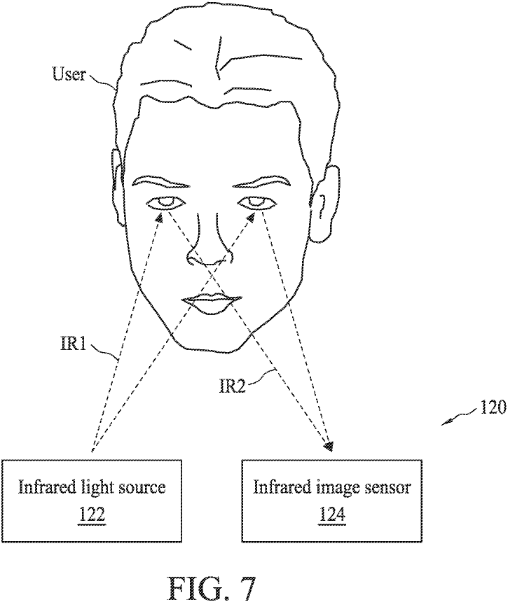

FIG. 7 shows the second image-sensing module 120 according to one embodiment of the present disclosure. As shown in FIG. 7, the second image-sensing module 120 includes an infrared light source 122 and an infrared image sensor 124. The infrared light source 122 may emit infrared light IR1 to the user, and the infrared image sensor 124 may acquire the user’s gaze data by sensing the infrared light IR2 reflected from the user. In such case, contours of the pupil and iris may be captured even more clearly, that is, the eye image IMGE may include more details and features, and thus, a result of the gaze tracking may be more accurate. However, the present disclosure is not limited thereto. In some other embodiments, a different scheme may be used to acquire the user’s gaze data according to the needs of the adopted gaze tracking algorithm.

In some embodiments, to reduce power consumption, the second image-sensing module 120 may only be enabled when the gaze-to-focus function is activated. Otherwise, if the autofocus function already meets the user’s requirement or the user chooses to adjust the focus by some other means, the gaze-to-focus function may not be activated, and the second image-sensing module 120 can be disabled accordingly.

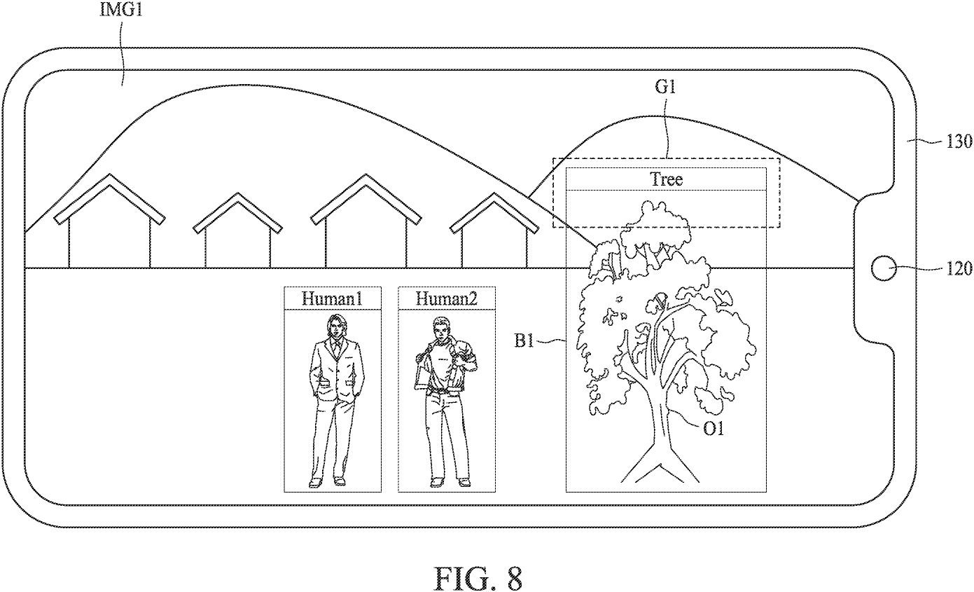

After the gazed region is detected in step S260, the second processor 150 may select a target from the detected objects having the labels in the preview image IMG1 according to the gazed region on the display panel 130 in step S270. FIG. 8 shows the display panel 130 of the image capturing system 100 according to one embodiment of the present disclosure. In FIG. 8, the display panel 130 displays the preview image IMG1 with labels of the three detected objects in the preview image IMG1, and the gazed region G1 detected in step S260 is also shown. Since the gazed region G1 overlaps with a label region of an object O1, it is determined that the user would like the first image-sensing module 110 to focus on the object O1. In the present embodiment, the label region of the object O1 may include the bounding box B1 surrounding the object O1 and the name “Tree” of the object O1 shown on the display panel 130. Consequently, the second processor 150 may select the object O1 as the target, and control the first image-sensing module 110 to perform a focusing operation with respect to the target for subsequent capturing operations in step S280.

In some embodiments, since the user may make saccades (scan) to the display panel 130 before he/she determines which object to focus on, the user may keep moving his/her gazed region until he/she makes a decision. In such case, steps S250 and S260 may be performed repeatedly to keep tracking the user’s gaze before the target is selected.

Furthermore, to allow the user to check if he/she is gazing at the object of interest, the second processor 120 may change a visual appearance of the label of the object at which the user is gazing. For example, the second processor 120 may select a candidate object from the detected objects in the preview image IMG1 when a label region of candidate object overlaps with the gazed region, and may change a visual appearance of the label of the candidate object so as to visually distinguish the candidate object from other objects in the preview image, thereby allowing the user to check if the candidate object is his/her target.

After the user has determined the target, the user may further express his/her confirmation to the image capturing system 100 so that the second processor 120 can decide the target accordingly. For example, the second processor 150 may decide the object O1 in the preview image IMG1 to be the target after the user has looked at the gazed region for a predetermined period, for example but not limited to 0.1 seconds to 2 seconds, as the gazed region overlaps with the label region of the target. However, the present disclosure is not limited to thereto. In some embodiments, the second processor 150 may decide the object O1 to be the target when the user blinks a predetermined number of times within a predetermined period while the gazed region overlaps with the label region of the target. For example, once the user has determined his/her target by gazing at the corresponding region on the display panel 130, the user may blink twice within a short period. Accordingly, the second processor 150 or the first processor 140 may detect the blinks, and the second processor 150 can select the object O1 as the target, which has a label region overlapping with the gazed region.

Also, to allow the user to confirm which object he/she has selected by gazing, the second processor 120 may change a visual appearance of the label of the target once the target is selected. For example, in some embodiments, the second processor 120 may change the color of the bounding box B1 of the object that has been selected as the target. In this way, the user can clearly identify the selected object from others according to colors of the labels. Since the image capturing system 100 can display all of the objects been detected along with their labels, the user may select the target from the labeled objects shown on the display panel 130 directly by gazing. Therefore, the ambiguity caused by selecting multiple adjacent objects by touching can be avoided.

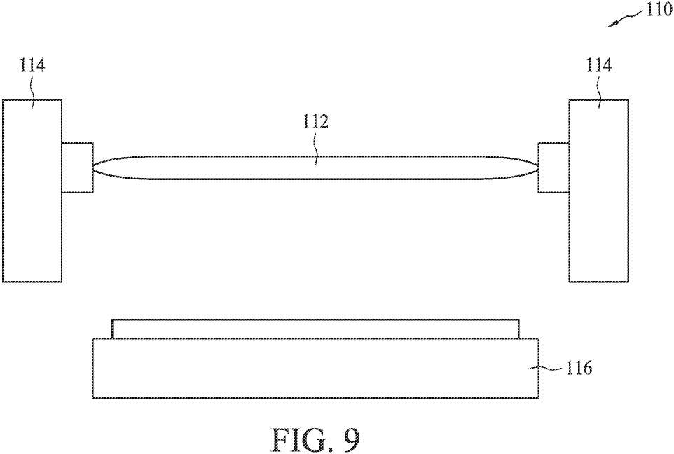

Once the target is selected, the second processor 150 may control the first image-sensing module 110 to perform a focusing operation with respect to the target in step S280 for subsequent capturing operations. FIG. 9 shows the first image-sensing module 110 according to one embodiment of the present disclosure. As shown in FIG. 9, the first image-sensing module 110 may include a lens 112, a lens motor 114, and an image sensor 116. The lens 112 can project images on the image sensor 116, and the lens motor 114 can adjust a position of the lens 112 so as to adjust a focus of the first image-sensing module 110. In such case, the second processor 150 may control the lens motor 114 to adjust the position of the lens so that the target selected in step S270 can be seen clearly in the image sensed by the image sensor 116. As a result, the user may take a picture of the desired scene with the first image-sensing module 110 focused on the target after step S280.

In the present embodiment, after the focus of the first image-sensing module 110 is adjusted with respected to the target, the second processor 150 may further track the movement of the target in step S290, and control the first image-sensing module 110 to keep the target in focus in step S292. For example, the first processor 140 and/or other processor(s) may extract features of the target in the preview image IMG1 and locate or track the moving target by feature mapping. In some embodiments, any known focus tracking technique that is suitable may be adopted in step S290. Consequently, after step S290 and/or S292, when the user commands the image capturing system 100 to capture an image, the first image-sensing module 110 captures the image while focusing on the target.

In summary, the image capturing system and the method for adjusting focus provided by the embodiments of the present disclosure allow the user to select the target that the first image-sensing module should focus on by gazing at the target shown on the display panel. Users can concentrate on holding and stabilizing the camera or the electronic device while composing a photo without touching the display panel for focusing, thereby not only simplifying an image-capturing process but avoiding shaking the image capturing system. Furthermore, since the objects in the preview image can be detected and labeled for the user to select from using gaze-based focus control, the focusing operation can be performed with respected to the target directly with greater accuracy.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image capturing system, comprising:
a first image-sensing module;
a plurality of processors comprising a first processor and a second processor, wherein the first processor is configured to detect a plurality of objects in a preview image sensed by the first image-sensing module and attach labels to the detected objects;
a display panel configured to display the preview image with the labels of the detected objects; and
a second image-sensing module for data acquisition of a user’s gaze; wherein:
the second processor is configured to select a target from the detected objects with the labels in the preview image according to a gazed region on the display panel that the user is gazing at, and to control the first image-sensing module to perform a focusing operation with respect to the target; and
at least one of the processors is configured to detect the gazed region on the display panel according to data of the user’s gaze acquired during the data acquisition.

2. The image capturing system of claim 1, wherein the first processor is an artificial intelligence (AI) processor comprising a plurality of processing units, and the first processor is configured to detect the objects according to a machine learning model.

3. The image capturing system of claim 1, wherein the second processor is further configured to perform a calibration process to project an eye movement angle of the user’s gaze onto a corresponding position on the display panel.

4. The image capturing system of claim 1, wherein the second image-sensing
module comprises:
an infrared light source configured to emit infrared light to the user; and
an infrared image sensor configured to acquire the user’s gaze data by sensing infrared light reflected from the user.

5. The image capturing system of claim 1, wherein the second image-sensing module is enabled when a gaze-to-focus function is activated so as to allow the user to select the target by gazing, and the second image-sensing module is disabled when the gaze-to-focus function is not activated.

6. The image capturing system of claim 1, wherein the second processor is further configured to track movement of the target and to control the first image-sensing module to perform the focusing operation for keeping the target in focus.

7. The image capturing system of claim 1, wherein the second processor decides the target after the user has looked at the gazed region for a predetermined period as the gazed region overlaps with a label region of the target.

8. The image capturing system of claim 1, wherein the second processor decides the target when the user blinks a predetermined number of times within a predetermined period while the gazed region overlaps with a label region of the target.

9. The image capturing system of claim 1, wherein the labels of the objects comprise at least one of serial numbers of the objects, names of the objects, and bounding boxes surrounding the objects.

10. The image capturing system of claim 1, wherein the second processor is further configured to select a candidate object from the detected objects when a label region of the candidate object overlaps with the gazed region, and to change a visual appearance of the label of the candidate object so as to visually distinguish the candidate object from other objects in the preview image.

11. A method for adjusting focus, comprising:
capturing, by a first image-sensing module, a preview image;
detecting a plurality of objects in the preview image;
attaching labels to the detected objects;
displaying, by a display panel, the preview image with the labels of the detected objects;
acquiring data of a user’s gaze;
detecting a gazed region on the display panel that the user is gazing at according to the user’s gaze data;
selecting a target from the detected objects with the labels in the preview image according to the gazed region; and
controlling the first image-sensing module to perform a focusing operation with respect to the target.

12. The method of claim 11, wherein the step of detecting objects in the preview image comprises detecting the objects in the preview image according to a machine learning model.

13. The method of claim 11, the step of detecting a gazed region on the display panel that the user is gazing at comprises performing a calibration process to project an eye movement angle of the user’s gaze onto a corresponding position on the display panel.

14. The method of claim 11, wherein the step of acquiring data of a user’s gaze comprises:
emitting infrared light to the user; and
acquiring the user’s gaze data by sensing infrared light reflected from the user.

15. The method of claim 11, further comprising:
enabling the second image-sensing module when a gaze-to-focus function is activated so as to allow the user to select the target by gazing; and
disabling the second image-sensing module when the gaze-to-focus function is not activated.

16. The method of claim 11, further comprising:
tracking movement of the target; and
controlling the first image-sensing module according to the target movement tracked to keep the target in focus.

17. The method of claim 11, wherein the step of selecting a target from the objects with the labels in the preview image comprises deciding the target after the user has looked at the gazed region for a predetermined period as the gazed region overlaps with a label region of the target.

18. The method of claim 11, wherein the step of selecting a target from the objects with the labels in the preview image comprises deciding the target when the user blinks a predetermined number of times within a predetermined period while the gazed region overlaps with a label region of the target.

19. The method of claim 11, wherein the labels of the objects comprise at least one of serial numbers of the objects, names of the objects, and bounding boxes surrounding the objects.

20. The method of claim 11, further comprising:
selecting a candidate object from the detected objects when a label region of the candidate object overlaps with the gazed region; and
changing a visual appearance of the label of the candidate object so as to visually distinguish the candidate object from other objects in the preview image.
